(19) United States
(12) Patent Application Publication
(10) Pub. No.: US 2014/0173310 A1
(43) Pub. Date: Jun. 19, 2014

(54) ELECTRONIC APPARATUS, CONTROL METHOD OF ELECTRONIC APPARATUS AND COMPUTER-READABLE MEDIUM

(71) Applicant: Kabushiki Kaisha Toshiba, Tokyo (JP)

(72) Inventor: Kazuhiko TSUJI, Hamura-shi (JP)

(73) Assignee: KABUSHIKI KAISHA TOSHIBA, Tokyo (JP)

(21) Appl. No.: 13/967,014

(22) Filed: Aug. 14, 2013

(30) Foreign Application Priority Data
Dec. 18, 2012 (JP) 2012-276143

(51) Int. Cl. G06F 1/32

(52) U.S. Cl. CPC G06F 1/3234
USPC 713/320

(57) ABSTRACT

An electronic apparatus includes a connection detector, an electric-power amount information acquisition module and an instruction module. The connection detector detects whether each of a plurality of electric-power supplies including a first electric-power supply and a second electric-power supply is connected to the electronic apparatus. The electric-power amount information acquisition module acquires total suppliable electric-power amount information representing a total suppliable electric-power amount supplied from the plurality of electric-power supplies detected to be connected to the electronic apparatus. The instruction module compares electric-power amount information representing an amount of electric-power used in a preset high-speed operation mode of a controller with the total suppliable electric-power amount information, and instructs, when the amount of electric-power used in the high-speed operation mode of the controller is larger than the total suppliable electric-power amount, the controller to operate in a mode in which consumed electric-power is lower.

### CROSS-REFERENCE TO RELATED APPLICATION(S)

This application is based upon and claims the benefit of priority from Japanese Patent Application No. 2012-276143, filed Dec. 18, 2012; the entire contents of which are incorporated herein by reference.

### FIELD

Embodiments of the present invention relate to an electronic apparatus, a control method of an electronic apparatus, and a computer-readable medium.

### BACKGROUND

In recent years, electronic apparatuses, such as a personal computer (PC), have been widespread, which can be used within the range of thermal design power (TDP) by preliminarily setting a mode in which the operating frequency of a central processing unit (CPU (controller)) is temporarily increased.

Each of these electronic apparatuses can be used in a state in which the operating frequency of CPU (controller) is high.

However, in recent years, there has been a demand for increasing the operating frequency of CPU set in the above mode outside the range of the TDP specification to make the electronic apparatus perform a higher-speed operation.

Thus, it has been a problem to provide an electronic apparatus which can increase the operating frequency of CPU (controller) set in the above mode outside the range of the TDP specification, if necessary.

### BRIEF DESCRIPTION OF THE DRAWINGS

FIG. 1 is a diagram illustrating the external-appearance of an electronic apparatus (PC) according to an embodiment.

FIG. 2 is a block diagram illustrating the configuration of the electronic apparatus (PC) according to the embodiment.

FIG. 3 is a block diagram illustrating a primary part of the configuration of the electronic apparatus according to the embodiment.

FIG. 4 is a flowchart illustrating a control operation in a high-speed operation mode of the electronic apparatus (PC) according to the embodiment.

FIG. 5 is a flowchart illustrating an operation of controlling externally-connected electric-power supplies of the electronic apparatus (PC).

### DETAILED DESCRIPTION

According to one embodiment, an electronic apparatus includes a connection detector, an electric-power amount information acquisition module and an instruction module. The connection detector detects whether each of a plurality of electric-power supplies including a first electric-power supply and a second electric-power supply is connected to the electronic apparatus. The electric-power amount information acquisition module acquires total suppliable electric-power amount information representing a total suppliable electric-power amount supplied from the plurality of electric-power supplies detected to be connected to the electronic apparatus. The instruction module compares electric-power amount information representing an amount of electric-power used in a preset high-speed operation mode of a controller with the total suppliable electric-power amount information, and instructs, when the amount of electric-power used in the high-speed operation mode of the controller is larger than the total suppliable electric-power amount, the controller to operate in a mode in which consumed electric-power is lower.

Various embodiments will be described hereinafter with reference to the accompanying drawings.

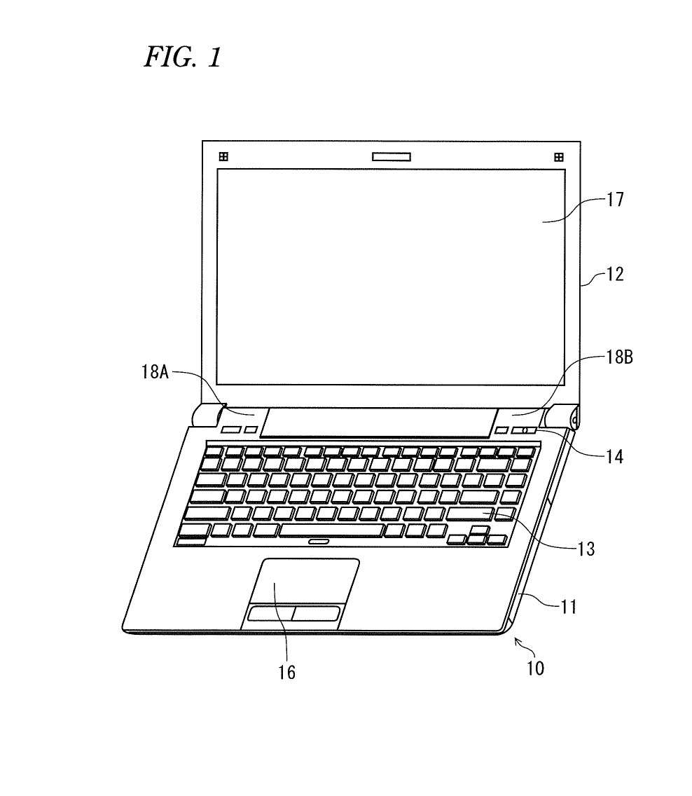

FIG. 1 is a diagram illustrating the external-appearance of an electronic apparatus (PC) according to the embodiment.

In this embodiment, the electronic apparatus (PC) 10 is implemented as, e.g., a notebook personal computer (hereunder referred to as a notebook PC or simply as PC).

However, the electronic apparatus (PC) 10 according to this embodiment is not limited to PC and can be adapted to a tablet PC, a cellular phone, a smartphone, a portable electronic apparatus, a television set, or the like.

In this embodiment, description is made using a personal computer as an example of the electronic apparatus (PC) 10.

The electronic apparatus (PC) 10 includes, e.g., a computer (notebook PC) main-body 11 and a video display portion 12. The video display portion 12 incorporates, e.g., a liquid crystal display (LCD).

The video display portion 12 is attached to the computer (notebook PC) main-body 11 rotatably between an open position in which the top surface of the computer (notebook PC) main-body 11 is exposed, and a closed position in which the top surface of the computer (notebook PC) main-body 11 is covered therewith.

The computer (notebook PC) main-body 11 has a thin box-shaped casing, on the top surface of which a keyboard 13, a power button 14 for powering on/off the electronic apparatus (PC) 10, a touch pad 16, speakers 18A and 18B, and the like are arranged.

For example, the right side of the computer (notebook PC) main-body 11 is provided with a universal serial bus (USB) connector (not shown), to which a USB cable or device complying with the USB 2.0 standard is connected.

The back-surface of the computer (notebook PC) main-body 11 is provided with, e.g., an external display connection terminal complying with the high-definition multimedia interface (HDMI) standard. The external display connection terminal is used for outputting digital video signals to an external display.

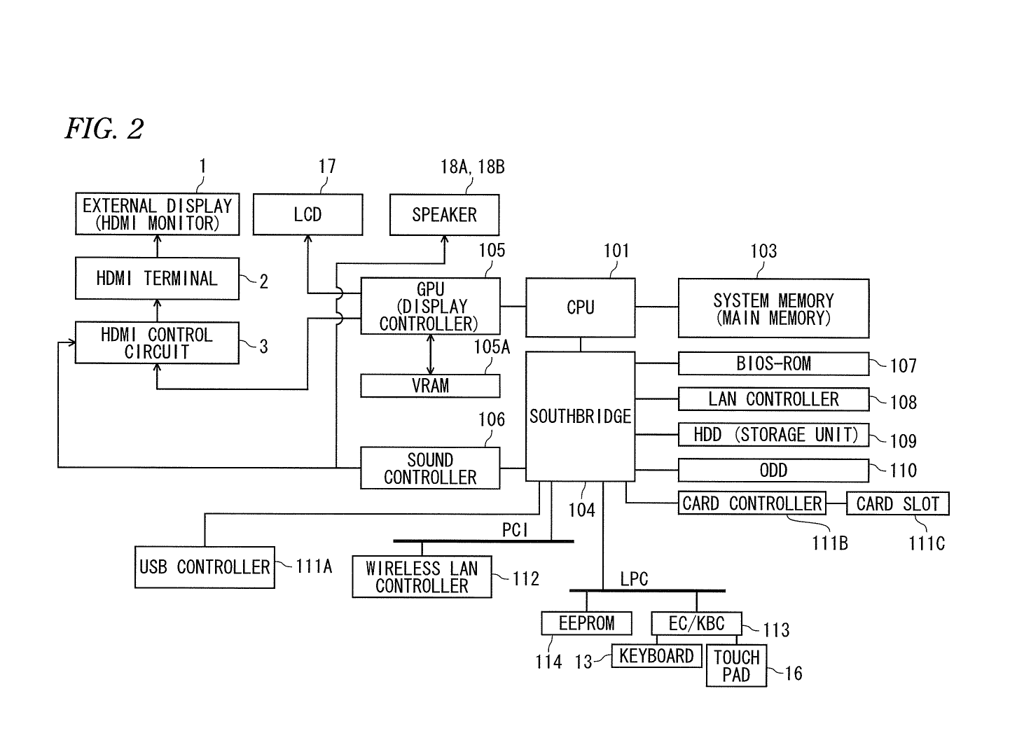

FIG. 2 is a block diagram illustrating the configuration of the electronic apparatus (PC) according to this embodiment.

As shown in FIG. 2, the electronic apparatus (PC) includes, e.g., a central processing unit (CPU) 101, a system memory (main memory) 103, a southbridge 104, a graphics processing unit (GPU) 105, a video random access memory (VRAM) 105A, a sound controller 106, a basic input/output system-read-only memory (BIOS-ROM)) 107, a local area network (LAN) controller 108, a hard disk drive (HDD (storage device)) 109, an optical disk drive (ODD) 110, a USB controller 111A, a card controller 111B, a card slot 111C, a wireless LAN controller 112, an embedded controller/keyboard controller (EC/KBC) 113, and an electrically erasable programmable ROM (EEPROM) 114.

The CPU (system-on-chip (SOC)) 101 is a processor that controls operations of each portion of the electronic apparatus (PC) 10.

The CPU (SOC) 101 runs a BIOS stored in the BIOS-ROM 107. The BIOS is a program for hardware control. The CPU (SOC) 101 also incorporates a memory controller that access-controls a system memory (main memory) 103. The CPU (SOC) 101 also has a function of performing communication with the GPU 105 via, e.g., a PCI EXPRESS standard serial bus.

The GPU 105 is a display controller that controls the LCD 17 used as a display monitor of the electronic apparatus (PC) 10.

Display signals generated by the GPU 105 are sent to the LCD 17. The GPU 105 can also send digital video signals to an external display 1 via an HDMI control circuit 3 and an HDMI terminal 2.

The HDMI terminal 2 is the above external display connection terminal The HDMI terminal 2 can send uncompressed digital video signals and digital audio signals to the external display 1 such as a television set via a single cable. The HDMI control circuit 3 is an interface for sending digital video signals to the external display 1 called “an HDMI monitor” via the HDMI terminal 2.

The southbridge 104 controls each device on a peripheral component interconnect (PCI) bus, and each device on a low pin count (LPC) bus. The southbridge 104 incorporates an integrated drive electronics (IDE) controller for controlling the HDD 109 and the ODD 110.

The southbridge 104 also has a function of performing communication with the sound controller 106.

The southbridge 104 is a sound source device and outputs reproduction target audio data to the speakers 18A and 18B or to the HDMI control circuit 3. The LAN controller 108 is a wired communication device that performs wired communication complying with, e.g., the Institute of Electrical and Electronics Engineers (IEEE) 802.3 standard. On the other hand, the wireless LAN controller 112 is a wireless communication device that performs wireless communication complying with, e.g., the IEEE 802.11g standard. The USB controller 111A performs communication with external devices that are compatible with, e.g., the USB 2.0 standard.

The USB controller 111A is used for, e.g., receiving image data files stored in digital cameras. The card controller 111B writes and reads data to and from a memory card, such as a secure digital (SD) card, which is inserted into a card slot provided in the computer (notebook PC) main-body 11.

The EC/KBC 113 is a one-chip microcomputer in which an embedded controller for electric-power management, and a keyboard controller for controlling the keyboard 13 and the touch pad 16 are integrated. The EC/KBC 113 has a function of powering on/off the electronic apparatus (PC) 10 in response to a user's operation of the power button 14.

Display control according to this embodiment is performed by, e.g., causing the CPU (SOC) 101 to run a program stored in the system memory (main memory) 103, the HDD 109, or the like.

In this embodiment, “OS” is an abbreviation of an operating system.

The OS is software providing fundamental functions, e.g., input/output functions such as keyboard input and screen output, and disk/memory management functions, which are utilized in common by many kinds of application software. In this embodiment, the OS is stored in, e.g., the HDD 109.

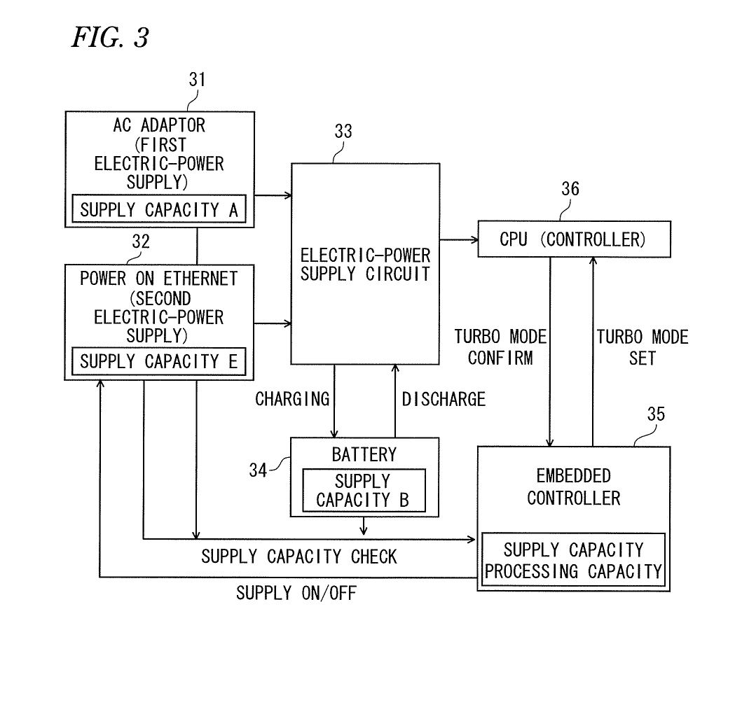

FIG. 3 is a block diagram illustrating a primary part of the configuration of the electronic apparatus (PC) according to the embodiment.

In this embodiment, an instruction module (embedded controller) 35 formed in the electronic apparatus (PC) 10 is connected to, e.g., a first electric-power supply (alternating current (AC) adapter) 31 and a second electric-power supply (Power over Ethernet (PoE (registered trademark))) 32. The electronic apparatus (PC) 10 includes a connection detector that detects electrical connection to each of the first electric-power supply and the second electric-power supply.

In this embodiment, the instruction module (embedded controller) 35 is also connected to a battery 34. The connection detector also detects electrical connection to the battery 34.

An electric-power amount information acquisition module calculates and acquires total suppliable electric-power amount information representing a total suppliable electric-power amount that can be supplied from plural power sources (i.e., the first electric-power supply (AC adapter) 31, the second electric-power supply (PoE) 32, and, e.g., the battery 34).

The instruction module (embedded controller) 35 compares information representing an amount of electric-power used in a preset high-speed operation mode of the controller (CPU) 36 with the total suppliable electric-power amount information calculated and acquired as described above. If the amount of electric-power used in the high-speed operation mode of the controller (CPU) 36 is larger than the total suppliable electric-power amount, the instruction module (embedded controller) 35 instructs the controller (CPU) 36 to operate in an operation mode in which consumed electric-power is lower.

An electric-power supply circuit 33 is connected to the plural electric-power supplies (i.e., the first electric-power supply (AC adapter) 31, the second electric-power supply (PoE) 32, and, e.g., the battery 34) and supplies electric-power to the electronic apparatus (PC) 10.

In this embodiment, the electric-power supply circuit 33 acquires information concerning an amount of electric-power suppliable by each of the plural electric-power supplies (i.e., the first electric-power supply (AC adapter) 31, the second electric-power supply (PoE) 32, and, e.g., the battery 34) from a corresponding one of the plural electric-power supplies. Then, the electric-power supply circuit 33 supplies the acquired information to the controller (CPU) 36.

For example, in a case where the electric-power supply capacity of the first electric-power supply (AC adaptor) 31 is “A”, where that of the second electric-power supply (PoE) 32 is “E”, and where that of the battery 34 is “B”, a total suppliable electric-power amount represented by total suppliable electric-power amount information is “A+E+B”.

If, e.g., the battery 34 is removed and unused for supplying electric-power, the total suppliable electric-power amount represented by the total suppliable electric-power amount information is “A+E”.

The instruction module (embedded controller) 35 is connected to the controller (CPU) 36, confirms the preset high-speed operation mode of the controller (CPU) 36, and instructs the setting and the change of the high-speed operation mode (turbo mode) of the controller (CPU) 36.

Hereinafter, the preset “high-speed operation mode (turbo mode)” of the controller (PC) 36 is described.

In this embodiment, the “high-speed operation mode (turbo mode)” is a CPU's multilevel operation mode preliminarily set in the CPU.

The “high-speed operation mode (turbo mode)” of the controller (PC) 36 is a mode in which the operating frequency of the CPU is increased to exceed a specification value.

The concept of the “turbo mode” was proposed by Intel Corporation, which is an American company, as a part of “Intel Turbo Boost Technology”.

The basic concept of the “turbo mode” is described hereinafter.

A cooling mechanism for an electronic apparatus (PC) is formed to meet the TDP specifications of the CPU.

The TDP is a maximum heat radiation amount of a microprocessor (CPU), which is a design assumption. That is, the TDP is a performance measure indicating how much heat is generated in a state in which all circuits of a microprocessor (CPU) ceaselessly work. The TDP (thermal design power) sometimes called “thermal design point”.

The TDP is based on electric-power consumed by a CPU in a case where a work load of a CPU is a CPU load which makers assume, and where a microprocessor (CPU) operates at a frequency determined by the specifications.

Therefore, in the case of using a multi-core CPU, if some of CPU cores are put into a sleep state, the actual electric-power consumption of the CPU is lower than the TDP.

Thus, in a “turbo mode”, power budget (or power margin) corresponding to the quantity of decrease in the power consumption of the CPU is allocated to active CPU cores.

That is, particularly, the drive voltage of the CPU is raised so as to increase the operating frequency of the active CPU cores.

Consequently, the power consumption of the active CPU cores increases. However, as described above, the power consumption of the sleep CPU cores is low. Thus, the power consumption of the entire CPU is within the range of the TDP.

For example, plural modes are preliminarily set as the “turbo mode”. For instance, a “turbo mode 1” and a “turbo mode 2” are preliminarily set. Alternatively, a “turbo mode 1”, a “turbo mode 2”, and a “turbo mode 3” are preliminarily set.

For example, if the usual power consumption of the CPU is 35 watts (W), the upper limit of the power consumption in the “turbo mode 1” is set at 45 W. The upper limit of the power consumption in the “turbo mode 2” is set at a value (e.g., 50 W) higher than that of the power consumption in the “turbo mode 1”.

The state of each of such “turbo modes” holds for about 20 seconds (S) to about 1 minute.

The increase of the operating frequency of each of the CPU cores enables the application of the electronic apparatus according to this embodiment broadly to desktop PCs and servers.

Hereinafter, the “PoE (Power over Ethernet (registered trademark))” is described. The “PoE” is technology that allows electric-power supply over category 5 or better unshielded twisted pair (UTP) cables utilized in the wiring of Ethernet (registered trademark).

The “PoE” is standardized on June 2003 as IEEE 802.3af. The “PoE” is assumed to be utilized mainly in Web cameras, switching hubs, wireless LAN access points, Internet protocol (IP) phones, and the like located at places, the supply of electric-power to which is difficult.

There are two types of electric-power supply methods. One is type A using a data line in common as an electric-power supply line. The other is type B utilizing four pins unused in Ethernet standards 10BASE-T/100BASE-TX on a UTP cable.

The method of type A utilizes pins Nos. 1, 2, 3, and 6. The method of type B utilizes pins Nos. 4, 5, 7, and 8.

According to either of the methods of types A and B, power sourcing equipment (PSE) supplies electric-power up to 15.4 W at 48 volts (V), so that a powered device (PD) can use electric-power of 12.95 W.

The PSE can select one of product specifications respectively corresponding to the types A and B. However, the PD should be produced to be able to receive electric-power from either of the PSEs respectively corresponding to the types A and B.

Basically, electric-power supply according to the “PoE” can be utilized only by PoE-compliant apparatuses. However, if external devices such as an electric-power feeding unit and an electric-power receiving unit are provided as annexes to a PoE-noncompliant apparatus, even the PoE-noncompliant apparatus can be adapted to receive electric-power supplied according to PoE.

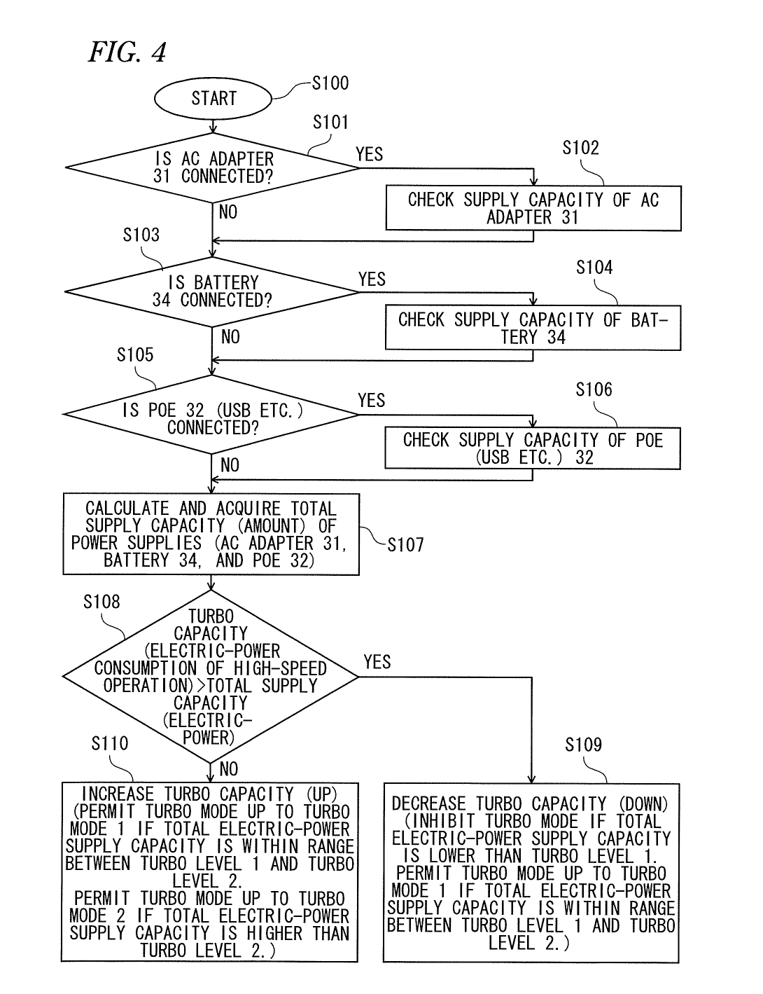

FIG. 4 is a flowchart illustrating a control operation in a high-speed operation mode of the electronic apparatus (PC) according to the embodiment.

Step S100 is a starting step of this control operation. Then, the operation proceeds to step S101.

Step S101 detects whether the first power supply (AC adapter) 31 is connected to the electronic apparatus (PC) 10. If step S101 detects that the first power supply (AC adapter) 31 is connected to the electronic apparatus (PC) 10 (Yes in step S101), the operation proceeds to step S102. If step S101 detects that the first power supply (AC adapter) 31 is not connected to the electronic apparatus (PC) 10 (No in step S101), the operation proceeds to step S103.

Step S102 checks the electric-power supply capacity of the first electric-power supply (AC adaptor) 31. In this embodiment, the electric-power supply capacity of the first electric-power supply (AC adaptor) 31 is, e.g., “A”. Next, the operation proceeds to step S103.

Step S103 detects whether, e.g., the battery 34 is connected to the electronic apparatus (PC) 10. If step S103 detects that the battery 34 is connected to the electronic apparatus (PC) 10 (Yes in step S103), the operation proceeds to step S104. If step S103 detects that the battery 34 is not connected to the electronic apparatus (PC) 10 (No in step S103), the operation proceeds to step 5105.

Step S104 checks the electric-power supply capacity of the battery 34. Then, the operation proceeds to step S 105.

Step S105 detects whether the second electric-power supply (PoE) 32 serving as an external electric-power supply is connected to the electronic apparatus (PC) 10. If step S105 detects that the second electric-power supply (PoE) 32 serving as an external electric-power supply is connected to the electronic apparatus (PC) 10 (Yes in step S105), the operation proceeds to step S106. If step S103 checks that the second electric-power supply (PoE) serving as an external electric-power supply is not connected to the electronic apparatus (PC) 10 (No in step S105), the operation proceeds to step S107.

In this embodiment, an external electric-power supply using USB or the like can be used as the second electric-power supply 32, instead of the “PoE”.

Step S106 checks the electric-power supply capacity of the second electric-power supply (PoE, USB, or the like) 32 serving as the external electric-power supply. In this embodiment, the electric-power supply capacity of the “PoE” is, e.g., “E”. Then, the operation proceeds to step S107.

Step S107 calculates and acquires a total electric-power supply capacity (total suppliable electric-power amount) of the electric-power supplies (in this embodiment, the first electric-power supply (AC adapter) 31, the battery 34, and the second electric-power supply (PoE) 32) connected to the electronic apparatus (PC) 10. Then, the operation proceeds to step S 108.

Step S108 compares electric-power amount information used in a preset high-speed operation mode (“turbo mode”) of the controller (CPU) 36 with the above total suppliable electric-power amount information (the total electric-power supply capacity (or electric-power amount)).

If the electric-power amount represented by the electric-power amount information used in a preset high-speed operation mode (“turbo mode”) is greater than that represented by the total suppliable electric-power amount information (the total electric-power supply capacity (or electric-power amount)), i.e., turbo capacity (i.e., power consumption during the high-speed operation of the controller (CPU) 36 in the above “turbo mode”) is greater than the total electric-power supply capacity (electric-power amount) (Yes in step S108), the operation proceeds to step S109.

If the electric-power amount represented by the electric-power amount information used in a preset high-speed operation mode (“turbo mode”) is not greater than that represented by the total suppliable electric-power amount information (the total electric-power supply capacity (or electric-power amount)), i.e., turbo capacity (i.e., power consumption during the high-speed operation of the controller (CPU) 36 in the above “turbo mode” is not greater than the total electric-power supply capacity (electric-power amount) (No in step S108), the operation proceeds to step S110.

Step S109 lowers the turbo capacity (i.e., the power consumption during the high-speed operation of the controller (CPU) 36 in the above “turbo mode” (“turbo capacity down”)).

In addition, if the total electric-power supply capacity of the plural power supplies is lower than the electric-power amount level (i.e., “turbo level 1”) in the turbo mode 1, the step S109 inhibits the “turbo mode”. If the total electric-power supply capacity of the plural power supplies is within a range between the electric-power amount level (i.e., the “turbo level 1”) in the turbo mode 1 and the electric-power amount level (i.e., the “turbo level 2”) in the turbo mode 2, the step S109 permits the turbo mode up to the “turbo mode 1” (corresponding to the “turbo level 1”).

Step S110 raises the turbo capacity (“turbo capacity up”).

In addition, if the total electric-power supply capacity of the plural power supplies is within a range between the electric-power amount level (i.e., the “turbo level 1”) in the turbo mode 1 and the electric-power amount level (i.e., the “turbo level 2”) in the turbo mode 2, the step S110 permits the turbo mode up to the “turbo mode 1” (corresponding to the “turbo level 1”). If the total electric-power supply capacity of the plural power supplies is higher than the electric-power amount level (i.e., the “turbo level 2”) in the turbo mode 2, the step S109 permits the “turbo mode” up to the “turbo mode 2” (corresponding to the “turbo level 2”).

That is, in this embodiment, if the electric-power supply by the second power supply (PoE (which can be changed to USB or the like)) is detected in addition to the electric-power supply by the first power supply (Ac adapter (which may include the battery 34)), the total electric-power supply capacity of the plural power supplies connected to the electronic apparatus (PC) 10 is calculated.

Then, the total electric-power supply capacity calculated as described above is compared with the power consumption in each of the turbo mode 1 (corresponding to the “turbo level 1”) and the turbo mode 2 (corresponding to the “turbo level 2”). If the total electric-power supply capacity is lower than the electric-power amount level (i.e., the “turbo level 1”) in the turbo mode 1, the “turbo mode” (corresponding to the “turbo level”) is inhibited.

If the total electric-power supply capacity is within a range between the electric-power amount level (i.e., the “turbo level 1”) in the turbo mode 1 and that (i.e., the “turbo level 2”) in the turbo mode 2, the turbo mode up to the turbo mode 1 (corresponding to the “turbo level 1) is permitted. If the total electric-power supply capacity is higher than the electric-power amount level (i.e., the “turbo level 2”) in the turbo mode 2, the turbo mode up to the turbo mode 2 (corresponding to the “turbo level 2”) is permitted.

For example, in a control-operation of controlling the externally-connected electric-power supplies of the electronic apparatus (PC) 10, the electric-power supply capacity of each of the plural power supplies (the AC adapter 31, the battery 34, and the “PoE” 32) connected to the electronic apparatus (PC) 10 is checked. In addition, the total electric-power supply capacity is calculated.

Then, the “total electric-power supply capacity” calculated as described above is compared with the power consumption value in each turbo mode (i.e., each of the turbo mode 1, the turbo mode 2, and the like). A turbo mode corresponding to the “total electric-power supply capacity” of the plural power supplies is set.

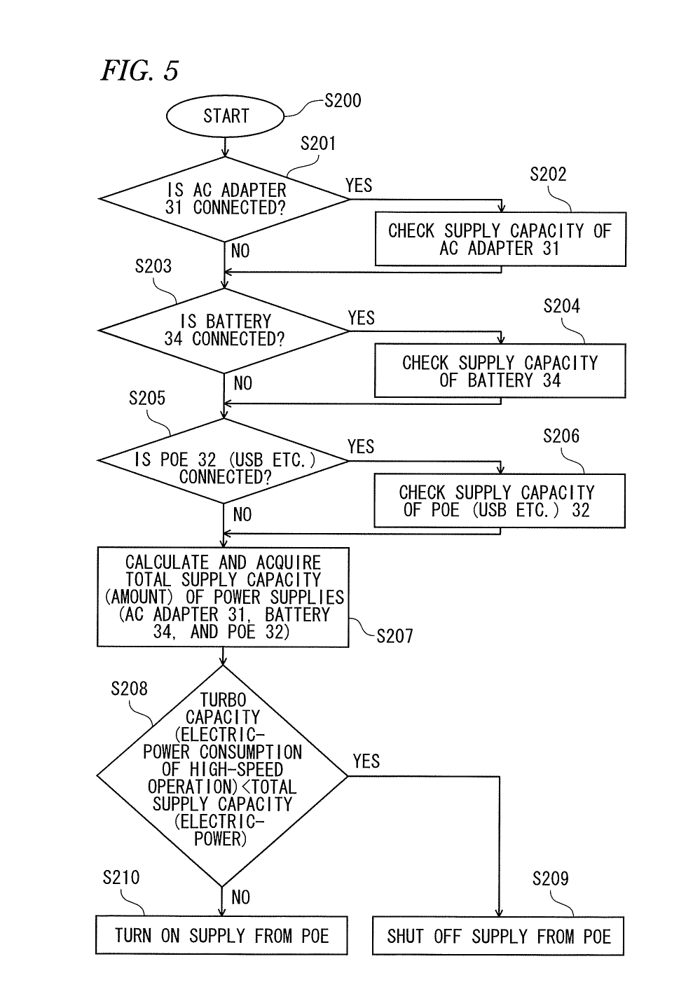

For example, in an operation of controlling the power supplies externally-connected to the electronic apparatus (PC) 10 (see FIG. 5), the electric-power supply capacity of each of the plural power supplies (i.e., the AC adapter 31, the battery 34, the “PoE” 32, and the like) connected to the electronic apparatus (PC) 10 is checked (in steps S201 to S206 illustrated in FIG. 5, which respectively correspond to steps S101 to S106 illustrated in FIG. 4). In addition, the “total electric-power supply capacity is calculated (in step S207 illustrated in FIG. 5).

Then, the “total electric-power supply capacity” calculated (in step S207) is compared with the power consumption in each turbo mode (i.e., each of the turbo mode 1, the turbo mode 2, and the like) is compared (in step S208).

If the “total electric-power supply capacity” of the plural power supplies is higher than the power consumption value in each turbo mode, the electric-power supply from, e.g., the second electric-power supply “PoE” 32 serving as an external electric-power supply is controlled to be shut off (in step S209).

Consequently, the supply of electric-power from the second electric-power supply is interrupted. Thus, e.g., DC-DC conversion loss can be reduced.

That is, in this embodiment, the “total electric-power supply capacity of the plural power supplies (e.g., the first power supply (AC adapter) 31, the battery 34, and the second power supply (PoE) 32) connected to the electronic apparatus (PC) 10 is calculated. Consequently, the turbo mode can be set such that a processing speed is optimal.

For example, in a case where the plural electronic-power supplies (e.g., the first power supply (AC adapter) 31, the battery 34, and the second power supply (PoE) 32) are such that the electric-power supply capacity of the “PoE” 32 <that of the battery 34 <that of the AC adapter 31, and where the electric-power supply connected to the electronic apparatus (PC) 10 is only the battery 34, e.g., the turbo mode is turned off.

If the electric-power supply connected to the electronic apparatus (PC) 10 is only the AC adapter 31, the apparatus (PC) 10 is set in, e.g., the turbo mode 1.

If the electric-power supplies connected to the electronic apparatus (PC) 10 are the battery 34 and the PoE 32, the apparatus (PC) 10 is set in, e.g., the turbo mode 1.

If the electric-power supplies connected to the electronic apparatus (PC) 10 are the AC adapter 31 and the PoE 32, the apparatus (PC) 10 is set in, e.g., the turbo mode 2.

If the electric-power supplies connected to the electronic apparatus (PC) 10 are the AC adapter 31 and the battery 34, the apparatus (PC) 10 is set in, e.g., the turbo mode 3.

If the electric-power supplies connected to the electronic apparatus (PC) 10 are the AC adapter 31, the battery 34, and the PoE 32, the apparatus (PC) 10 is set in, e.g., the turbo mode 4.

Even if the AC adapter 31, whose suppliable electric-power is low, is mounted on this embodiment, the electronic apparatus (PC) 10 can achieve performance which is comparable with that achieved in the case where the standard AC adapter 31 is mounted thereon in combination with the plural electric-power supplies, as described above.

In a case where the supply capacity of the plural power supplies is such that, e.g., the electric-power supply capacity of the “PoE” 32 <that of the battery 34=that of a small AC adapter 31, and where the electric-power supply connected to the electronic apparatus (PC) 10 is only the battery 34, for example, the turbo mode is turned off.

If the electric-power supply connected to the electronic apparatus (PC) 10 is only the AC adapter 31, for example, the turbo mode is turned off.

If the electric-power supplies connected to the electronic apparatus (PC) 10 are the battery 34 and the PoE 32, for example, the turbo mode is turned off.

If the electric-power supplies connected to the electronic apparatus (PC) 10 are the AC adapter 31 and the PoE 32, the electronic apparatus (PC) 10 is set in, e.g., the turbo mode 1.

If the electric-power supplies connected to the electronic apparatus (PC) 10 are the AC adapter 31 and the battery 34, the electronic apparatus (PC) 10 is set in, e.g., the turbo mode 2.

If the electric-power supplies connected to the electronic apparatus (PC) 10 are the AC adapter 31, the battery 34 and the PoE 32, the electronic apparatus (PC) 10 is set in, e.g., the turbo mode 3.

Consequently, in the normal turbo mode 1, in a case where the total electric-power supply capacity of the AC adapter 31 and the PoE 32 is sufficient, and where the electric-power amount level (i.e., “turbo level 1”) in the turbo mode 1 can be achieved only by the AC adapter 31, the supply of electric-power from the PoE 32 is interrupted (see step S209 illustrated in FIG. 5). Thus, e.g., DC/DC conversion loss can be reduced.

That is, in this embodiment, the instruction module (embedded controller) 35 formed in the electronic apparatus (PC) 10 is connected to the first power supply (AC adapter) 31 and the second power supply (PoE) 32. The electronic apparatus (PC) 10 includes a connection detector that detects electrical connection to each of the first electric-power supply (AC adapter) 31 and the second electric-power supply (PoE) 32.

The instruction module (embedded controller) 35 is also connected to a battery 34 in addition to the first electric-power supply (AC adapter) 31 and the second electric-power supply (PoE) 32. The connection detector also detects electrical connection to the battery 34.

An electric-power amount information acquisition module calculates and acquires total suppliable electric-power amount information representing a total suppliable electric-power amount that can be supplied from plural power supplies (i.e., the first electric-power supply (AC adapter) 31, the second electric-power supply (PoE) 32, and, e.g., the battery 34).

The instruction module (embedded controller) 35 compares information representing an amount of electric-power used in a preset high-speed operation mode of the controller (CPU) 36 with the total suppliable electric-power amount information calculated and acquired as described above. If the amount of electric-power used in the high-speed operation mode of the controller (CPU) 36 is larger than the total suppliable electric-power amount, the instruction module (embedded controller) 35 instructs the controller (CPU) 36 to operate in an operation mode in which consumed electric-power is lower.

An electric-power supply circuit 33 is connected to the plural electric-power supplies (i.e., the first electric-power supply (AC adapter) 31, the second electric-power supply (PoE) 32, and, e.g., the battery 34) and supplies electric-power to the electronic apparatus (PC) 10.

In this embodiment, the electric-power supply circuit 33 acquires information concerning an amount of electric-power suppliable by each of the plural electric-power supplies (i.e., the first electric-power supply (AC adapter) 31, the second electric-power supply (PoE) 32, and, e.g., the battery 34) from a corresponding one of the plural electric-power supplies. Then, the electric-power supply circuit 33 supplies the acquired information to the controller (CPU) 36.

In this embodiment, the electronic apparatus (PC) 10 may inhibit an operation in a high-speed operation mode if an amount of electric-power used in the high-speed operation mode of the controller (CPU) 36 is larger than the total suppliable electric-power amount.

In the electronic apparatus (PC) 10, the above high-speed operation mode (turbo mode) may include plural modes such as a first mode, a second mode, a third mode, and the like.

If an amount of electric-power used in a high-speed operation mode (turbo mode) of the controller (CPU) 36 is lower than the total suppliable electric-power amount, the electronic apparatus (PC) 10 may instruct the controller (CPU) 36 to operate in an operation mode in which power consumption is larger.

The electronic apparatus (PC) 10 compares electric-power amount information representing an amount of electric-power used in a preset high-speed operation mode of the controller (CPU) 36 with the “total suppliable electric-power amount information”. If the amount of electric-power used in the preset high-speed operation mode (turbo mode) of the controller (CPU) 36 is lower than the total suppliable electric-power amount of the plural electric-power supplies, the electronic apparatus (PC) 10 may control the supply of electric-power from the second electric-power supply to be shut off (see step S209 illustrated in FIG. 5).

If the amount of electric-power used in the high-speed operation mode (turbo mode) of the controller (CPU) 36 is larger than the total suppliable electric-power amount of the plural electric-power supplies, the electronic apparatus (PC) 10 may control the supply of electric-power from the second power supply to be shut off (see step S210 illustrated in FIG. 5).

The electronic apparatus (PC) 10 may be such that electric-power of the above first electronic-power supply is supplied from an AC adapter, and that the above second power supply is an external electric-power supply different from the first electric-power supply.

Consequently, the electronic apparatus (PC) according to this embodiment can set an optimal high-speed operation mode (turbo mode) meeting the supply capacity by calculating, e.g., the total electric-power supply capacity of the plural electric-power supplies connected to the electronic apparatus (PC) 10 and comparing the total electric-power supply capacity with the electric-power consumed in the high-speed operation mode (turbo mode).

For example, electric-power supplied from the second electric-power supply (PoE) or the like can appropriately be controlled by favorably setting the high-speed operation mode (turbo mode). For instance, the loss of electric-power due to electric-power conversion can be reduced.

With the above configuration, according to this embodiment, an electronic apparatus can be provided, which can raise the operating frequency of CPU (controller), which is set in the above mode, out of the range of the TDP specification.

The procedure of the control processing according to this embodiment can fully be implemented by software. Thus, effects similar to those of this embodiment can be easily achieved only by installing, in a normal computer via a computer-readable storage medium, a program that implements the procedure of the control processing.

The above embodiment is not intended to limit the invention to the description thereof. The invention can be embodied by variously changing the components thereof without departing from the gist in the implementation step.

The invention can be embodied in various forms according to appropriate combinations of the components disclosed in the embodiment described above.

For example, some components may be deleted from all components shown in the embodiment. Further, the components in different embodiments may be used appropriately in combination.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a connection detector configured to detect whether each of a plurality of electric-power supplies including a first electric-power supply and a second electric-power supply is connected to the electronic apparatus;
an electric-power amount information acquisition module configured to acquire total suppliable electric-power amount information representing a total suppliable electric-power amount supplied from the plurality of electric-power supplies detected to be connected to the electronic apparatus; and
an instruction module configured to compare electric-power amount information representing an amount of electric-power used in a preset high-speed operation mode of a controller with the total suppliable electric-power amount information, and to instruct, when the amount of electric-power used in the high-speed operation mode of the controller is larger than the total suppliable electric-power amount, the controller to operate in a mode in which consumed electric-power is lower.

2. The electronic apparatus of claim 1,
wherein the instruction module inhibits an operation in the high-speed operation when the amount of electric-power used in the high-speed operation mode of the controller is larger than the total suppliable electric-power amount.

3. The electronic apparatus of claim 1,
wherein the high-speed operation mode includes a first mode and a second mode.

4. The electronic apparatus of claim 1,
wherein the instruction module instructs, when the amount of electric-power used in the high-speed operation mode of the controller is smaller than the total suppliable electric-power amount, the controller to operate in a mode in which consumed electric-power is higher.

5. An electronic apparatus comprising:
a connection detector configured to detect whether each of a plurality of electric-power supplies including a first electric-power supply and a second electric-power supply is connected to the electronic apparatus;
an electric-power amount information acquisition module configured to acquire total suppliable electric-power amount information representing a total suppliable electric-power amount supplied from the plurality of electric-power supplies detected to be connected to the electronic apparatus; and
an electric-power controller configured to compare electric-power amount information representing an amount of electric-power used in a preset high-speed operation mode of a controller with the total suppliable electric-power amount information, and to control, when the amount of electric-power used in the high-speed operation mode of the controller is smaller than the total suppliable electric-power amount, supply of electric-power from the second electric-power supply to be shut off.

6. The electronic apparatus of claim 5,
wherein the electric-power controller controls, when the amount of electric-power used in the high-speed operation mode of the controller is larger than the total suppliable electric-power amount, supply of electric-power from the second electric-power supply to be turned on.

7. The electronic apparatus of claim 1,
wherein electric-power from the first electric-power supply is supplied from an AC adapter, and
wherein the second electric-power supply is an external power supply differing from the first electric-power supply.

8. A control method of an electronic apparatus comprising:
detecting whether each of a plurality of electric-power supplies including a first electric-power supply and a second electric-power supply is connected to the electronic apparatus;
acquiring total suppliable electric-power amount information representing a total suppliable electric-power amount supplied from the plurality of electric-power supplies detected to be connected to the electronic apparatus;
comparing electric-power amount information representing an amount of electric-power used in a preset high-speed operation mode of a controller with the total suppliable electric-power amount information; and
instructing, when the amount of electric-power used in the high-speed operation mode of the controller is larger than the total suppliable electric-power amount, the controller to operate in a mode in which consumed electric-power is lower.

9. A non-transitory computer-readable medium storing a program that causes an electronic apparatus to execute a control processing comprising:
detecting whether each of a plurality of electric-power supplies including a first electric-power supply and a second electric-power supply is connected to the electronic apparatus;
acquiring total suppliable electric-power amount information representing a total suppliable electric-power amount supplied from the plurality of electric-power supplies detected to be connected to the electronic apparatus;
comparing electric-power amount information representing an amount of electric-power used in a preset high-speed operation mode of a controller with the total suppliable electric-power amount information; and
instructing, when the amount of electric-power used in the high-speed operation mode of the controller is larger than the total suppliable electric-power amount, the controller to operate in a mode in which consumed electric-power is lower.
